(19) United States
(12) Patent Application Publication
(10) Pub. No.: US 2008/0177683 A1
(43) Pub. Date: Jul. 24, 2008

(54) METHOD AND APPARATUS FOR MOBILE INTELLIGENCE

(76) Inventors: Brian Y. No, Kent, WA (US); John G. Asay, Olympia, WA (US); Brian McGiverin, Newsoms, VA (US); John Haager, Bonney Lake, WA (US)

Correspondence Address: DUKE W. YEE, YEE & ASSOCIATES, P.C., P.O. BOX 802333, DALLAS, TX, 75380, US

(21) Appl. No.: 11/626,125

(22) Filed: Jan. 23, 2007

(51) Int. Cl. G06F 15/18; G06N 5/00; G06N 7/02

(52) U.S. Cl. 706/15; 706/45; 706/52

(57) ABSTRACT

A computer implemented method, apparatus, and computer usable program code for processing sensor data. A network data processing system contains a server, and a plurality of mobile clients. Each mobile client executes on a node using an artificial intelligence process and a memory model located at the node. Each mobile client also receives data from a set of sensors associated with the node to form sensor data, processes the sensor data using the artificial intelligence process and the memory model, and identifies an action based on processing the sensor data. Each mobile client also selectively sends results from processing the sensor data to the server in response to encountering a selected event at the node and receives an update to the memory model based on results from another mobile client. The update provides an ability to process sensor data with respect to new events.

### BACKGROUND INFORMATION

1. Field of Invention

The present invention relates generally to an improved data processing system and in particular, to a method and apparatus for processing data. Still more particularly, the present invention relates to a computer implemented method, apparatus, and computer usable program code for processing data using clients having limited bandwidth.

2. Background Description

Currently, maintenance and logistics systems are centralized. In many vehicle fleets, a vehicle device collects and transmits data directly from the vehicle to a server in this centralized system. The data may include, for example, vehicle location, fuel consumption, mileage, speed, and warnings generated by sensors. In these examples, the server may access the on-board computer, allowing for data to be obtained from equipment functioning outside set parameters. Further, this server may send out notices or e-mails to technicians if a diagnostic trouble code is detected. In this manner, technicians may address problems as they start. Even parameters, such as emissions, may be tracked.

These types of systems, however, often require availability of bandwidth to transfer data back to the centralized system. Problems occur with this type of centralized model when the vehicles are unable to communicate with the server in the centralized system.

Therefore, it would be advantageous to have an approved computer implemented method, apparatus, and computer usable program code for managing client systems, such as vehicles.

### SUMMARY OF THE INVENTION

An embodiment of the present invention provides a computer implemented method, apparatus, and computer usable program code for processing sensor data. A network data processing system contains a server, and a plurality of mobile clients. Each mobile client executes on a node using an artificial intelligence process and a memory model located at the node. Each mobile client also receives data from a set sensors associated with the node to form sensor data, processes the sensor data using the artificial intelligence process and the memory model, and identifies an action based on processing the sensor data, Each mobile client also selectively sends results from processing the sensor data to the server in response to encountering a selected event at the node and receives an update to the memory model based on results from another mobile client. The update provides an ability to process sensor data with respect to new events.

In another advantageous embodiment, a computer implemented method for processing sensor data is provided. A set of sensors associated with a node on which the computer implemented method is executing is monitored to obtain sensor data. The sensor data is processed using an artificial intelligence process to identify an action. A memory model is updated and stored on the node based on the processing of the sensor data to form an updated memory model. A message is sent to a server on a network data processing system if the action identified from processing the sensor data indicates that a message is to be sent to the server. The memory model is updated using the update to form an updated memory model in response to receiving an update from the server. Subsequent processing of sensor data is made using the updated memory model.

In yet another advantageous embodiment, a computer program product having a computer usable medium having computer usable program code for processing sensor data is present for monitoring a set of sensors associated with a node on which the computer implemented method is executing to obtain sensor data. Also, computer usable program code for processing the sensor data using an artificial intelligence process to identify an action is included. Computer usable program code is present for updating a memory model stored on the node based on the processing of the sensor data to form an updated memory model. Computer usable program code is included for sending a message to a server on a network data processing system if the action identified from processing the sensor data indicates that a message is to be sent to the server. In addition, computer usable program code, responsive to receiving an update from the server, for updating the memory model using the update to form an updated memory model is present. Subsequent processing of sensor data is made using the updated memory model.

The features, functions, and advantages can be achieved independently in various embodiments of the present invention or may be combined in yet other embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an advantageous embodiment of the present invention when read in conjunction with the accompanying drawings, wherein:

FIG. 1 is a pictorial representation of a network of data processing systems in which the advantageous embodiments may be implemented;

FIG. 2 is a diagram of a data processing system in accordance with an advantageous embodiment of the present invention;

FIG. 3 is a diagram illustrating a mobile intelligence system in accordance with an advantageous embodiment of the present invention;

FIG. 4 is a diagram of a master database in accordance with an advantageous embodiment of the present invention;

FIG. 5 is a diagram of a master model in accordance with an advantageous embodiment of the present invention;

FIG. 6 is a diagram illustrating an associative memory in accordance with an advantageous embodiment of the present invention;

FIG. 7 is a block diagram of a mobile client in accordance with an advantageous embodiment of the present invention;

FIG. 8 is a flowchart of a process for processing data retrieved from sensors in accordance with an advantageous embodiment of the present invention;

FIG. 9 is a flowchart of a process for generating an observation in accordance with an advantageous embodiment of the present invention;

FIG. 10 is a flowchart of a process for updating a memory model in accordance with an advantageous embodiment of the present invention;

FIG. 11 is a flowchart of a process for handling messages identifying failures at a mobile client in accordance with an advantageous embodiment of the present invention; and

FIG. 12 is a flowchart of a process for analyzing a failure received from a mobile client in accordance with an advantageous embodiment of the present invention.

### DETAILED DESCRIPTION OF THE INVENTION

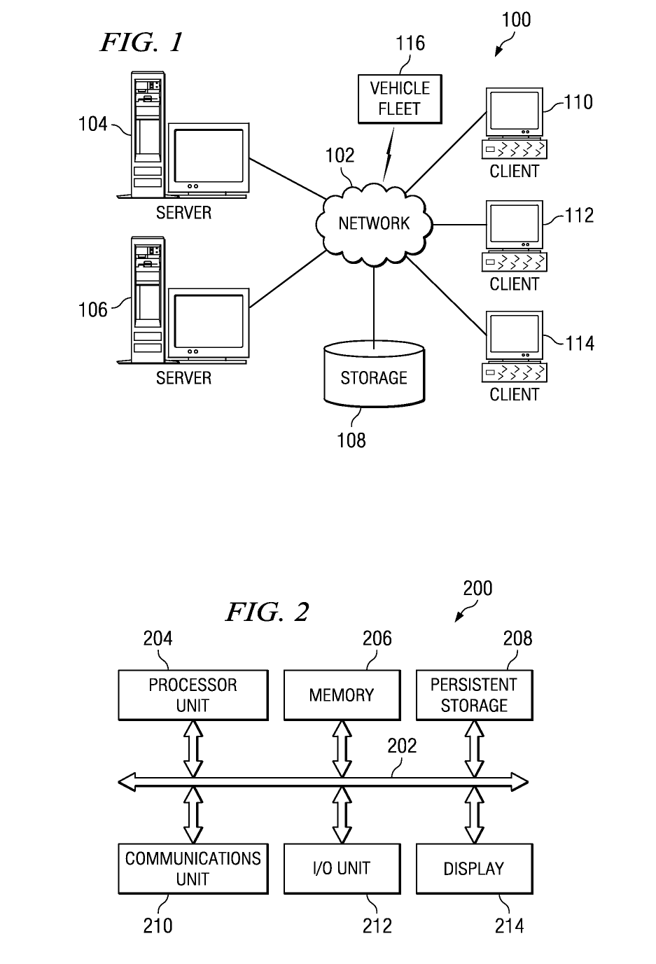

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

Turning now to FIG. 1, a pictorial representation of a network of data processing systems is depicted in which advantageous embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example.

Additionally, vehicle fleet 116 also may be a client to servers 104 and/or 106. In these examples, vehicle fleet 116 may be a number of different types of vehicles. For example, vehicle fleet 116 may be aircraft, ships, submarines, automobiles, trucks, and/or trains. Vehicle fleet 116 may be homogenous or heterogeneous in its makeup depending on the particular implementation. In other works vehicle fleet 116 may be all of the same type of vehicles or different types of vehicles.

In these examples, vehicle fleet 116 is in communication with servers 104 and 106 through wireless communication links. Also, depending on the particular implementation, more than one vehicle fleet may be in communication with these servers. The vehicles in fleet 116 are examples nodes or endpoints in these examples.

The different advantageous embodiments of the present invention may be implemented within network data processing system 100 to provide mobile intelligence within vehicle fleet 116. Each of the vehicles in vehicle fleet 116 includes a data processing system, which may be used to collect and process data. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

Turning now to FIG. 2, a diagram of a data processing system is depicted in accordance with an advantageous embodiment of the present invention. Data processing system 200 is an example of a data processing system that may be used to implement different computers and devices in network data processing system 100 in FIG. 1. For example, data processing system 200 may be used to implement computers or data processing systems located within mobile clients, such as vehicles in vehicle fleet 116. Data processing system 200 also may be used in other data processing systems, such as mobile phones and personal digital assistants (PDAs). Further, data processing system 200 may be used to implement servers and clients, such as server 106 and client 110 in FIG. 1.

In this illustrative example, data processing system 200 includes communications fabric 202, which provides communications between processor unit 204, memory 206, persistent storage 208, communications unit 210, I/O unit 212, and display 214.

Processor unit 204 serves to execute instructions for software that may be loaded into memory 206. Processor unit 204 may be a set of one or more processors or may be a multi-processor core, depending on the particular implementation. Further, processor unit 206 may be implemented using one or more heterogeneous processor systems in which a main processor is present with secondary processors on a single chip. Memory 206, in these examples, may be, for example, a random access memory. Persistent storage 208 may take various forms depending on the particular implementation. For example, persistent storage 208 may be, for example, a hard drive, a flash memory, a rewritable optical disk, a rewritable magnetic tape, or some combination of the above.

Communications unit 210, in these examples, provides for communications with other data processing systems or devices. In these examples, communications unit 210 is a network interface card. I/O unit 212 allows for input and output of data with other devices that may be connected to data processing system 200. For example, I/O unit 212 may provide a connection for user input though a keyboard and mouse. Further, I/O unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206.

The advantageous embodiments of the present invention provide a computer implemented method, apparatus, and computer usable program code for managing and analyzing data in a network data processing system. A network data processing system is present containing a server, and a plurality of mobile clients. Each mobile client executes on a node using an artificial intelligence process and a memory model located at the node, receives data from a set of sensors associated with the node to form sensor data, processes the sensor data using the artificial intelligence process and the memory model, identifies an action based on processing the sensor data, selectively sends results from processing the sensor data to the server in response to encountering a selected event at the node, and receives an update to the memory model based on results from another mobile client, wherein the update provides an ability to process sensor data with respect to new events.

The different illustrative embodiments recognize that currently used systems have disadvantages based on the centralization of processing and the bandwidth requirements needed to transfer data back and forth between end points and a centralized processing system.

The different illustrative embodiments employ mobile clients and memory objects in a manner to leverage processing of data collected by the mobile clients. In these examples, a mobile client is a software process. A mobile client is a client executing on a node that is mobile or moves, such as a vehicle. Mobile clients communicate using wireless communications links or may communicate intermittently when a connection to a wired link is available. Mobile clients in these illustrative examples employ artificial intelligence processes. In these illustrative examples, clients observe, record, and evaluate data to discover association or anomalies at nodes or endpoints on which the clients execute. The nodes in these examples are vehicles. Once data is evaluated, the information is transmitted by the mobile client to a server for use in a centralized database. The client transmitting the data and clients at other nodes may be updated with new knowledge to avoid having to experience the same situation.

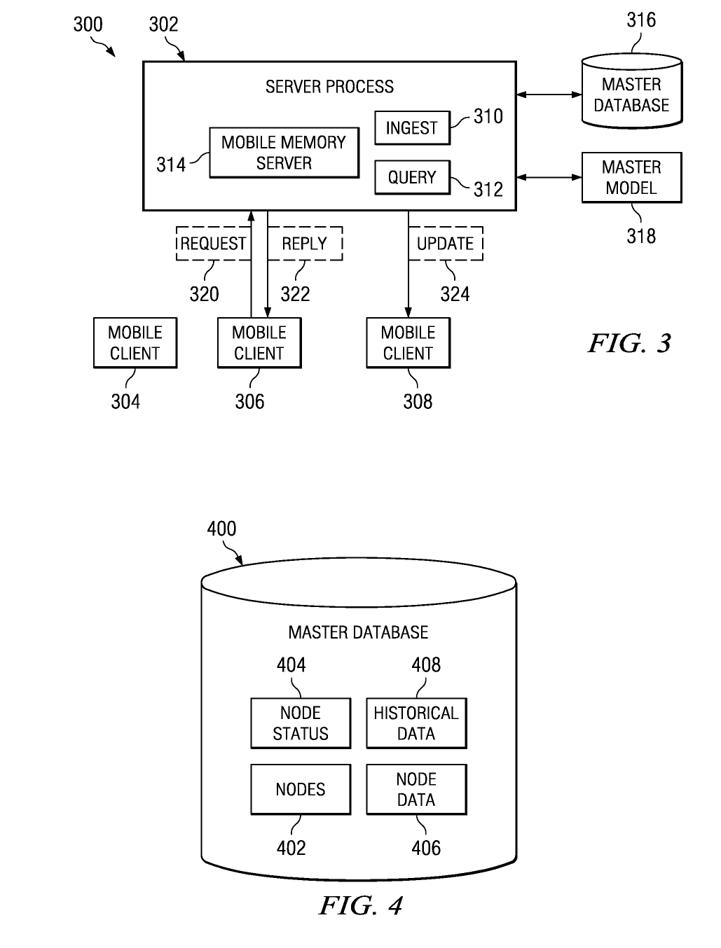

Turning now to FIG. 3, a diagram illustrating a mobile intelligence system is depicted in accordance with an advantageous embodiment of the present invention. Mobile intelligence system 300 may be implemented in a network data processing system, such as network data processing system 100 in FIG. 1.

In these depicted examples, server process 302 communicates with mobile clients 304, 306, and 308. Server process 302 may be located on a server, such as server 104 or 106 in FIG. 1. Mobile clients 304, 306, and 308 are processes that may be executing on nodes, such as client 110 or vehicle fleet 116 in FIG. 1.

In this illustrative example, server process 302 includes ingest 310, query 312, and mobile memory server 314. Mobile memory server 314 in server process 302 communicates with mobile clients 304, 306, and 308 and analyzes the data received from these mobile clients. The data received and the results of analysis made by mobile memory server 314 may be stored in master database 316 through calls made to ingest 310 and query 312.

Ingest 310 and query 312 are part of a database management system in server process 302 and reads and writes data in master database 316. Ingest 310 writes data into master database 316 while query 312 locates and retrieves data from master database 316 in response to calls made by mobile memory server 314. In these examples, master database 316 is a collection of data. This collection of data may be organized using a number of architectures or schemas.

Ingest 310, query 312, and master database 316 may be implemented using currently available database systems. For example, the processes in ingest 310 and query 312 may be implemented to use structured query language (SQL) to access data in master database 316. In these particular examples, ingest 310 and query 312 may be implemented using SaffronEnterprise™, which is available from Saffron Technology, Inc.

In these examples, master database 316 contains all of the data relating to the different mobile clients. Further, master database 316, in these examples, also contains data about the nodes on which the mobile clients execute as well as data collected and returned by mobile clients 304, 306, and 308.

Further, master database 316 also may contain results of analysis on the collected data. Master database 316 also may include other types of data depending on the particular implementation.

Mobile memory server 314 also manages master model 318. Mobile memory server 314 may retrieve memory models from master model 318 for user by mobile clients 304, 306, and 308. These memory models are also referred to “mobile memories” because they may be transferred to mobile clients 304, 306, and 308 in these illustrative examples.

Master model 318 contains memory models that are used by mobile clients 304, 306, and 308 to collect data, analyze data, and make decisions. These memory models contain knowledge or information used by mobile clients 304, 306, and 308 in processing data observed by these mobile clients. In these examples, the data is observed through the use of sensors associated with the nodes on which these clients execute.

Master model 318 may be established using existing memory models. Alternatively, a basic memory model may be created using training data to establish the baseline knowledge for the different memory models in master model 318.

In these depicted examples, master model 318 includes a model for each particular class and type of mobile client. For example, master model 318 may include memory models for different classes or types of trucks within a vehicle fleet. In other words each class or type of truck has a different memory model when compared to another class or type of truck. The differences in memory models are present in these embodiments to take into account differences between different classes or type of trucks.

Further, master model 318 may also include models for other types of vehicles, such as ships, aircraft, and tanks. When a mobile client is first initialized in these examples, mobile memory server 314 retrieves the appropriate model for the mobile client based on the type of vehicle or device on which the mobile client is to execute. Memory model server 314 sends the retrieved memory model to the mobile client that is being initialized. Further, mobile memory server 314 also sends new data or updates mobile clients 304, 306, and 308 in these examples.

Mobile memory server 314 accepts observations sent in messages from any mobile client in these examples. These observations are integrated into master model 318. Additionally, mobile memory server 314 also tracks the state of each client and updates the state in master model 318. In these examples, the state identifies the contents of mobile memory currently stored at the node on which the mobile client is executing. This state information is used to determine what updates a mobile client may need based on changes to master model 318. Further, mobile memory server 314 also may include processes to analyze data within master database 316 to identify additional results or conclusions that may be integrated into master model 318 and distributed to the different mobile clients affected by those results or conclusions as updates to their memory models.

In these examples, mobile client 304 may observe data that is different from the data observed by mobile client 306. As a result, the mobile memory maintained by mobile client 304 is different from the mobile memory maintained by mobile client 306. Further, the different memory models contain results of analysis made by the mobile clients. These results may differ between the different mobile clients.

In the illustrative examples, mobile clients 304, 306, and 308 are each designed to be as small in size as possible and still provide processes for collecting and analyzing data. However, depending on the particular implementation, the size of the code for mobile clients 304, 306, and 308 may not be a concern depending on the resources available. Further, the size of messages transmitted between mobile clients 304, 306, and 308 and mobile memory server 314 are selected in a manner to take into account that communications between these clients and mobile memory server 314 may be intermittent at times. In these examples, the message payloads are around ten kilobytes.

In addition, mobile clients 304, 306, and 308 include processes to maintain a stateless connection between these clients and mobile memory server 314. Communication only occurs when a message is to be sent between mobile memory server 314 and mobile clients 304, 306, and 308. Further, this type of stateless connection allows the connection to be maintained in the event of a communications link failure. If communication is initiated while the communications link is unavailable, these clients wait for the communications link to be re-established and automatically resume the transfer and complete the communications request.

For example, mobile client 304 may be unable to establish a communications link with mobile memory server 314, while mobile clients 306 and 308 are able to establish a communications link.

As a result, the different updates are tailored to the particular client receiving the updates. These updates are selected in a manner to ensure a minimally sized update is sent to a particular client to reduce bandwidth use. In these advantageous embodiments, a particular memory model used by a mobile client is complete and cumulative in master model 318. Mobile memory server 314 provides an ability to take pieces of the memory model and send it to the different clients. This model continually assimilates knowledge and information from the different clients. Mobile memory server 314 is then able to distribute the cumulative knowledge back out to the changes or updates to the clients.

In these examples, the transfer of messages and updates between mobile memory server 314 and mobile clients 304, 306, and 308 may be implemented using different communication technologies. In the illustrative embodiments, the processes for communicating with mobile memory server 314 may be implemented using Topia Mobile Object Technology, which is available from Topia Technology in Tacoma, Wash. In particular, Kolona™ is an infrastructure available from Topia Technology that enables mobile objects, such as memory models and updates to move application logic and data between data processing systems. This infrastructure may be employed in these illustrative examples to transfer mobile memories between different clients and a server.

In these examples, mobile client 306 may observe data and process the data locally at the node on which mobile client 306 executes. In this manner, mobile client 306 is not reliant upon mobile memory server 314 in server process 302 to function. In other words, mobile client 306 may make queries or perform an analysis using the mobile memory held locally to generate a result or conclusion. Further, if mobile client 306 encounters data that mobile client 306 cannot recognize or a failure occurs in the near future after encountering a set of data, mobile client 306 may send this data along with any observations to mobile memory server 314 through a message in the form of request 320.

Request 320, in these examples, contains a list of attributes for the data that is to be processed by mobile memory server 314. In response to receiving request 320, mobile memory server 314 processes the data and may analyze the data sent by mobile client 306 with other data received from other mobile clients, such as mobile client 304 and mobile client 308. The other data is stored in master database 316 in these examples. By having access to data from all of the mobile clients managed through mobile memory server 314, results may be identified that otherwise could not be made with only the data and knowledge held in a single mobile client.

The analysis made by mobile memory server 314 also may include other data from sources other than mobile clients 304, 306, and 308. In these examples, that data is also stored in master database 316. This data may become, for example, data gathered from other nodes of the same type that do not have mobile clients managed through mobile memory server 314. Further, this other type of data may be collected from other sources in addition to being retrieved from other nodes. For example, the data may be historical data recorded maintenance or repairs have been performed. In this manner, additional data may be made available for use in analyzing different events that occur with respect to mobile clients 304, 306, and 308.

Results from the processing of this data by mobile memory may be returned to mobile client 306 in reply 322. As depicted, reply 322 includes updates to the mobile memory server 314 for mobile client 306. In addition to and alternatively, reply 322 may contain other information such as failures or lists of errors.

The data and results also are stored in master database 316 and may be used to update the memory models within master model 318 for these mobile clients. Further, these updates may be returned to other mobile clients. For example, an update generated in response to request 320 by mobile client 306 may be returned in update 324 in these examples to mobile client 308. The update may not yet be sent to mobile client 304 if mobile client 304 cannot establish a communications link with mobile memory server 314. In this situation, update 324 is sent to mobile client 304 when that client is able to establish a communications link with mobile memory server 314.

As depicted, update 324 is a one-way message transmitted by mobile memory server 314 to mobile client 308 in these examples. The purpose of update 324 is to provide mobile client 308 with a current memory model. In these examples, update 324 is used to modify the mobile memory such that mobile client 308 has the most up-to-date information for use in processing and analyzing data gathered from sensors.

In these examples, no reply or return message is required to be sent to mobile memory server 314. Of course, depending on the particular implementation, mobile client 308 may return a confirmation that update 324 has been received.

Turning now to FIG. 4, a diagram of a master database is depicted in accordance with an advantageous embodiment of the present invention. In this example, master database 400 is a more detailed example of master database 316 in FIG. 3. Master database 400 contains all of the information and knowledge used by a mobile intelligence system, such as mobile intelligence system 300 in FIG. 3. In the depicted example, master database 400 contains nodes 402, which includes an identification of the different nodes on which mobile clients are executing. These nodes may take different forms depending on the particular implementation. For example, the nodes may be all of the same type or may be heterogeneous. When the nodes are heterogeneous, one type or class of node may be, for example, helicopters while another type is aircraft. The node also may take the form of a truck, tank, or some other vehicle. The node may even be a ship or submarine. Also, depending on the particular implementation, a node may be a portable computing device, such as a personal digital assistant or a notebook computer.

Node status 404 contains information about the status of each particular node. Node status 404 also may include information as to whether all of the components of a node functioning or whether components have failed. Further, node status 404 also may indicate whether a particular node is in communication with the mobile memory server. Of course, any other type of status information about nodes may be stored in node status 404.

Node data 406 in master database 400 contains information collected by the different mobile clients that have been returned to the mobile memory server. In these illustrative examples, the data is data collected by the mobile clients from sensors associated with the node. Further, this node data may also include events, such as identifications of failures within a node. Node data 406 also may contain results of analysis made by a mobile client. Node data 406 may include data that was not identified for use as an update to memory models in the master model. For example, anomalies may be recorded in node data 406.

Next, historical data 408 in these examples contains other data not collected from the different mobile clients at the nodes. Instead, this information may be obtained from other sources. For example, with respect to vehicles, historical data 408 may include information about maintenance schedules or failures that may occur when a particular type or set of data is detected by sensors on a vehicle.

The information illustrated in master database 400 is intended as examples of the type of information that may be stored within this database. Of course, other types of information may be used in addition to or in place of the data depicted depending on the particular implementation.

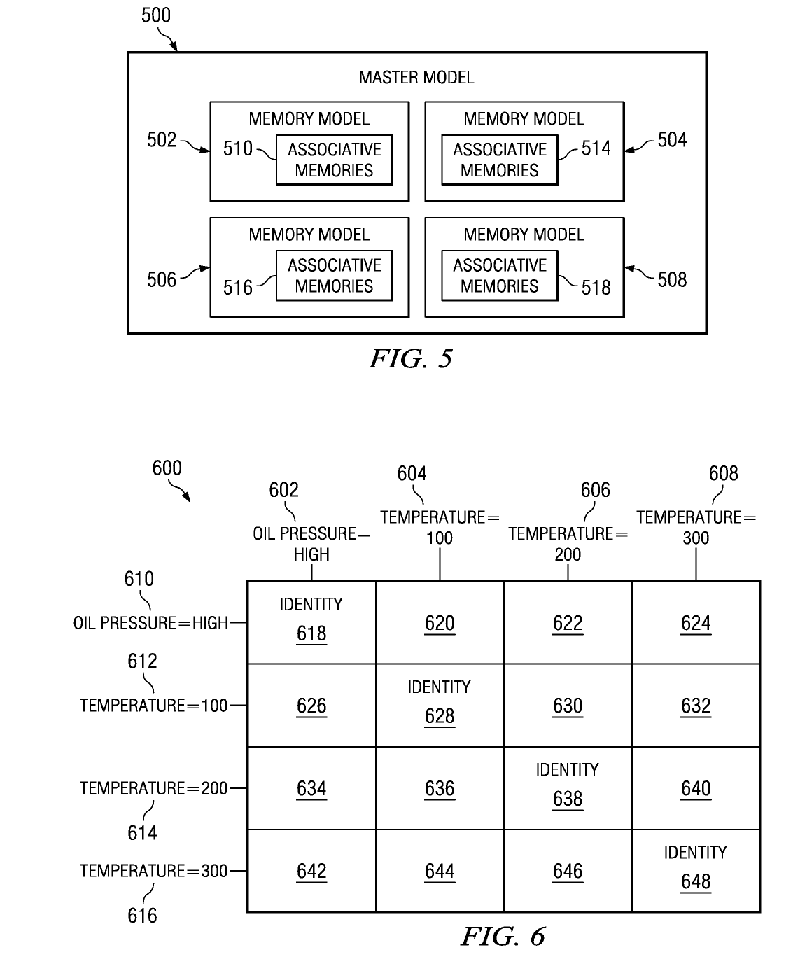

Turning next to FIG. 5, a diagram of a master model is depicted in accordance with an advantageous embodiment of the present invention. Master model 500 is a more detailed illustration of master model 318 in FIG. 3. Master model 500 contains memory models 502, 504, 506, and 508 in these examples. A memory model is a collection of one or more associative memories in these illustrative embodiments. The memory model is used by a mobile client such as mobile client 304 in FIG. 3 to process data gathered by observations made by the mobile client. This collection of associative memories may be one or more associative memories in these examples. Memory model 502 contains associative memories 510; memory model 504 contains associative memories 514; memory model 506 contains associative memories 516; and memory model 508 contains associative memories 518.

These memory models are similar to schemas for a database. Each of these memory models is associated or designated for use by a particular type or class of node. For example, memory model 502 may be used for helicopters, while memory model 504 may be used airplanes. Further, the associative memories in these different memory models are updated when the mobile memory server generates results or conclusions based on the analysis of data received from different mobile clients executing on the nodes.

Turning now to FIG. 6, a diagram illustrating an associative memory is depicted in accordance with an advantageous embodiment of the present invention. In this example, associative memory 600 is an example of an associative memory within associative memories 510 in FIG. 5. As depicted, associative memory 600 is a single square matrix. Associative memory 600 contains columns 602, 604, 606, and 608. Additionally, matrix 600 also contains rows 610, 612, 614, and 616.

Associative memory 600 contains cells 618, 620, 622, 624, 626, 628, 630, 632, 634, 636, 638, 640, 642, 644, 646, and 648. Each of these cells contains a value. Each cell typically signifies the number of times that the two attributes have occurred at the same time. In addition, the agent and the memory model making up a client at a node allows for the mobile client to make intelligent decisions even when the mobile client cannot communicate with the server.

In these examples, associative memory 600 is used to represent a case in which a failure may occur for a particular component. For example, with respect to nodes taken from vehicles, associative memory 600 may represent a case in which a component, such as a motor or communications unit may fail. Of course, these associative memories may be used to represent other types of situations or conditions. For example, associative memory 600 may represent information used to analyze whether an aircraft may encounter air turbulence. This associative memory also may be used to contain information for determining whether maintenance is required for a particular component in addition to whether an imminent failure may occur. In some cases, maintenance may be required to maintain the particular component at the desired operating efficiency and may not result in a failure without maintenance.

Each row and each column represents an attribute. A cell identified by a row and column represents an association between two attributes. In these examples, the rows have the same identified attributes as the columns. In this example, column 602 is oil pressure=high; column 604 is temperature=100; column 606 is temperature=200; and column 608 is temperature=300. Row 610 is oil pressure=high; row 612 is temperature=100; row 614 is temperature=200; and row 616 is temperature=300. Thus, if the mobile client observes that the temperature is at 100 and had an oil pressure of high, the mobile client indicates this occurrence in cell 626. This information also may be stored in cell 620 to provide a redundancy within associative memory 600. In other words, the metrics for this associative memory is redundant. This redundancy allows for looking up information starting with any attribute.

For example, the information in cells 634 and 622 are redundant. Cells 636 and 630 are redundant; cells 642 and 624 are redundant; cells 644 and 632 are redundant; and cells 646 and 640 are redundant to each other. Cells 618, 628, 638, and 648 are referred to as identity cells. These types of cells only identify a single attribute rather than two attributes as with the other cells. Identities are typically used to identify the number of times that an attribute has ever been observed. In some implementations, these cells are not used.

In this manner, associative memory 600 has redundancy and allows for lookup starting with any attribute. In some implementations, the associative memory is not represented as a square but a triangle or half-square.

In addition, with associative memory 600 columns and rows may be added to associative memory 600 unlike relational database models in which the columns are decided ahead of time and cannot be changed. In other words, associative memory 600 may start as a zero-by-zero metrics and grow as observations are made by the client.

Further, in some associative memories, the cells contain identification as to whether an association ever occurred using a value such as a one or zero. Moreover, associative memory 600 also may be implemented to count every time an association is seen between attributes. Also, the storage of data within associative memory 600 may be optimized using different processes. For example, a column or row order may be changed to move all the non-zero values towards one corner of the matrix.

Also, depending on the particular implementation a memory model may use other types of storage other than associative memory 600. For example, the information in the memory model may be implemented as a neural network.

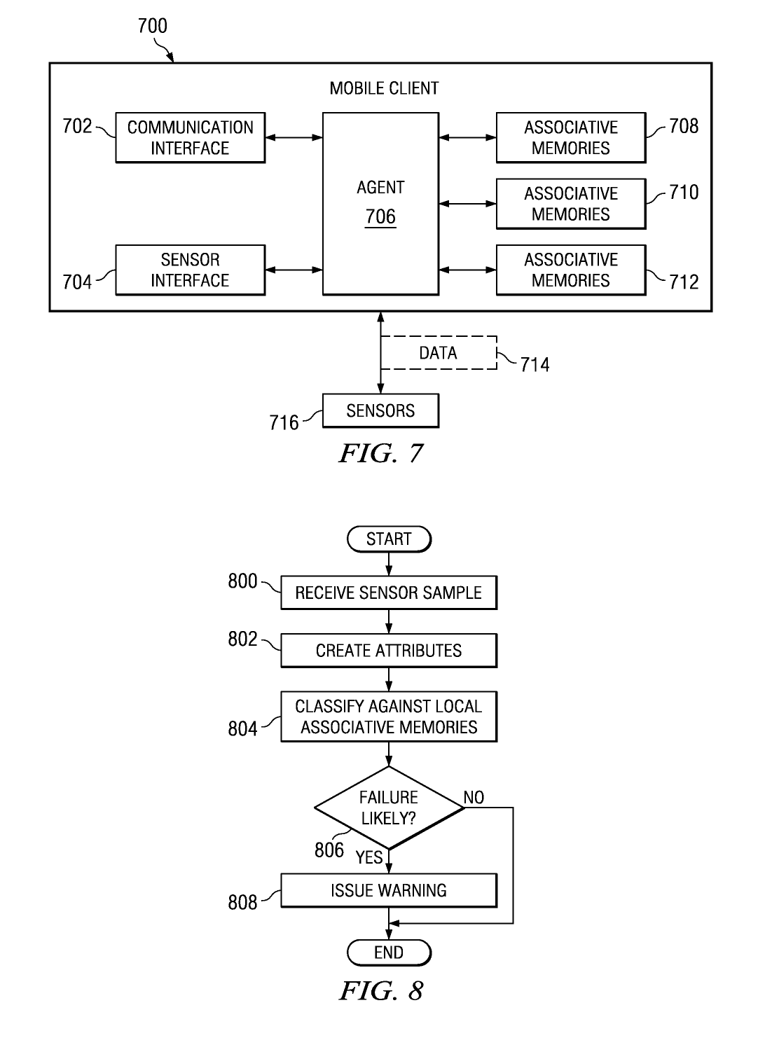

Turning now to FIG. 7, a block diagram of a mobile client is depicted in accordance with an advantageous embodiment of the present invention. In this example, mobile client 700 is an example of a mobile client, such as mobile client 306 in FIG. 3. Mobile client 700 includes communication interface 702, agent 706, and sensor interface 704. Additionally, mobile client 700 also includes associative memories 708, 710, and 712.

In these illustrative examples, mobile client 700 executes on a node in the form of a vehicle. Communication interface 702 provides processes to establish communications links with a mobile memory server, such as mobile memory server 314 in FIG. 3. Sensor interface 704 is used to retrieve data 714 from sensors 716. In these examples, sensors 716 is a set of one or more sensors associated with the node on which mobile client 700 is executing. These sensors may include sensors that measure parameters, such as, for example, temperature, fuel usage, speed, altitude, and failures in components.

Agent 706 is a manager of associative memories 708, 710, and 712. Agent 706 contains the processes needed to store and query information from associative memories 708, 710, and 712. Further, agent 706 is an intelligent agent that may learn from observations previously made based on data observed by collecting data from sensors 716. Agent 706 also includes processes to analyze data 714 using these associative memories. Agent 706 may be implemented using a number of different processes.

In the depicted examples, agent 706 includes artificial intelligence. An artificial intelligence system implemented in agent 706 may include machine learning characterized by formalism and statistical analysis. Artificial intelligence systems may include expert systems, cased-based reason systems, Bayesian networks, and behavior-based artificial intelligence.

Artificial intelligence systems also may include processes that have iterative development or learning. This type of system is also referred to as computational intelligence. Computational intelligence systems include, for example, neural networks, fuzzy systems, and evolutionary computation. Further, an artificial intelligence system may be hybrid that includes processes both from a conventional artificial intelligence and computational intelligence system.

For example, these processes in agent 706 may include at least one of an artificial intelligence program, a fuzzy logic system, and a neural network. In other words, agent 706 may be an artificial intelligence program, a fuzzy system, or a neural network. Further, a combination of these different types of components may be used in agent 706. Examples of artificial intelligence processes that may be used to implement agent 706 in these examples, may be found in Saffron One, which is a product from Saffron Technology, Inc. Of course any type of program or code that has processes for analyzing data and using memory models to come to conclusions or results may be implemented.

In these examples, an associative memory is maintained for each type of failure that may occur in a node. If a new type of failure occurs, the agent may create a new associative memory for that failure. In these examples, agent 706 classifies or compares a set of attributes, such as data from current sensor readings, against a failure case to determine whether the sensor readings look like or similar to those in any previously observed case in which a failure has occurred.

By using the data in the associative memories, agent 706 is able to determine whether data 714 collected from sensors 716 indicate that a failure may occur within a selected period of time. Based on the likelihood of a failure occurring within the selected period of time, agent 706 may identify an action to be taken. This action may be to generate a warning or message to the user of the node. The action may be to send information back to the mobile memory server in a message. The action also may be that no action would need to be taken at this time.

Additionally, mobile client 700 may receive additional associative memories through communication interface 702 from a mobile memory server. In this manner, mobile client 700 may benefit from analysis made by the mobile memory server or the analysis made by other mobile clients that have been transmitted to the mobile memory server. In this manner, the intelligence or results identified by a particular mobile client may be transferred to another mobile client through the mobile memory system architecture in system 300 in FIG. 3.

FIGS. 8-12 are flowcharts of processes that may be implemented in different components of a mobile intelligence system, such as mobile intelligence system 300 in FIG. 3. In these advantageous examples, the processes are directed towards nodes that take the form of vehicles in which the agents in the mobile clients monitor sensor data to prognosticate or predict failures and to analyze the occurrence of failures on those vehicles. The mobile memories used in these examples provide the information used to predict when a failure may occur such that maintenance or corrective actions be taken before such a failure. The creation and distribution of new associative memories allow a mobile client within a mobile intelligence system to learn not only from the observations made by that mobile client, but through the observations made by other mobile clients executing on other vehicles.

Turning now to FIG. 8, a flowchart of a process for processing data retrieved from sensors is depicted in accordance with an advantageous embodiment of the present invention. The process illustrated in FIG. 8 may be implemented in a mobile client, such as mobile client 700 in FIG. 7. Particularly, these processes may be implemented by an agent, such as agent 706 in FIG. 7.

The process begins by receiving a sensor sample (operation 800). The sensor sample in operation 800 is the data received from sensors associated with the vehicle on which the mobile client executes. The process creates attributes based on the received sensor sample (operation 802). In these examples, the attributes take the form of name value pairs. The process associates the data with names or variables. Thereafter, the attributes are classified against local associative memories (operation 804). Operation 804 compares the attributes created in operation 802 against different associative memories to determine whether failures that may occur. A determination is made as to whether a failure is likely (operation 806). In these examples a failure is likely if a match in an associative memory exceeds a selected threshold.

For example, a failure may be determined to be likely if a temperature detected by a temperature sensor exceeds 300 degrees more than seven times. Such an example is a simplified example. In actual use, the process may look at numerous attributes, such as a dozen or more and determine if their combination, as well as trending data, indicates the failure may occur.

The associative memory may provide information that such a condition typically results in a failure of the component within some selected period of time, such as 24 hours.

If a failure is determined to be likely, a warning is issued (operation 808) with the process terminating thereafter. The warning issued in operation 808 is made because the current sensor readings are considered to be indicative of an immanent failure of a component in the vehicle. With reference again to operation 806, if a failure is not determined to be likely, the process terminates. The actions identified in this example are to generate a warning or to take no action.

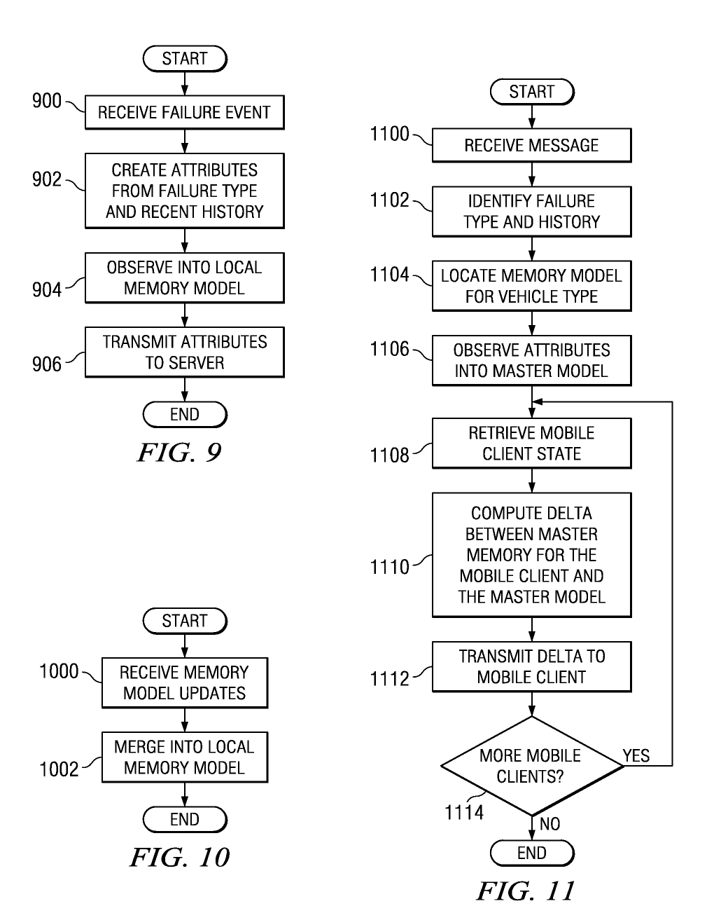

Turning now to FIG. 9, a flowchart of a process for generating an observation is depicted in accordance with an advantageous embodiment of the present invention. The process illustrated in FIG. 9 may be implemented in a mobile client, such as mobile client 700 in FIG. 7. In particular, the process may be implemented in an agent, such as agent 706 in FIG. 7. The process in FIG. 9 is used to process an occurrence of an event detected by mobile client executing on a vehicle. In the depicted examples, the event is a failure of the component.

The process begins by receiving a failure event (operation 900). This failure event may be detected through sensors associated with the vehicle. Thereafter, attributes are created from the failure type and recent history (operation 902). In these examples, each mobile client maintains a “recent history” log for some fixed period of time. When a failure occurs, the process bundles the log with a failure to indicate that a particular series of events and/or readings occur before the failure. This information may be used as trending data as discussed above.

In operation 902, the process may generate attributes by identifying an associative memory containing the failure type along with the particular parameter, such as a type of sensor reading. Thereafter, the attributes are observed or written into the local memory model (operation 904).

Depending on the failure that has occurred, the update may be made to an existing local associative memory. If an associative memory for the failure type is not present, the mobile client has not previously seen or encountered this particular type of failure. With this situation, a new associative memory may be generated for the new type of failure in operation 904.

Thereafter, attributes are transmitted to a mobile memory server (operation 906) with the process terminating thereafter. Transmitting these attributes to the mobile memory server allows for this information to be shared with other mobile clients. The attributes identified with the failure also may be used by the mobile memory server to perform additional analysis using data gathered from other mobile clients or other sources.

The prediction of whether the failure may occur may be made possible through analyzing data gathered from other sources with respect to the particular type of failure encountered by the mobile client.

For example, data from other mobile clients or other sources regarding the type of failure may make it possible to determine statistically when such a failure is likely to occur. The data may be transmitted to a mobile memory server in response to events other than a failure. For example, a mobile client may transmit data when an event in the form of an anomaly occurs. As a simple example, the anomaly may be a temperature reading that is not characteristic of the particular component. Although a failure may never have occurred on the mobile client with respect to this anomaly, the mobile client may send the data to the mobile memory server for analysis with other data that the mobile memory client cannot access. The analysis of the anomaly by the mobile memory server with data gathered from other mobile clients in other sources may provide a basis to predict whether and when a failure may occur when such an anomaly is present. In actual implementation, the anomaly is likely to be this unexpected temperature reading in the context of the values of other attributes.

In this manner, failures may be predicted prior to their occurrences in a more efficient manner by allowing other mobile clients to learn from the experience of a particular mobile client.

Turning now to FIG. 10, a flowchart of a process for updating a memory model is depicted in accordance with an advantageous embodiment of the present invention. The process illustrated in FIG. 10 may be implemented in a mobile client, such as mobile client 700 in FIG. 7. In particular, this process may be implemented by an agent, such as agent 706 in FIG. 7.

The process begins by receiving a set of memory model updates (operation 1000). This set of memory model updates may be one or more updates for the memory model for the mobile client. In these examples, the updates take the form of associative memories that may take the place or add to the associative memories in the memory model of the mobile client. The process then merges the updates into local memory model (operation 1002) with the process terminating thereafter.

Turning now to FIG. 11, a flowchart of a process for handling messages identifying failures at a mobile client is depicted in accordance with an advantageous embodiment of the present invention. The process illustrated in FIG. 11 may be implemented in a server process, such as server process 302 in FIG. 3. In particular, the process illustrated in this figure may be implemented in a mobile memory server, such as mobile memory server 314 in FIG. 3.

The process begins by receiving a message from a mobile client (operation 1100). In response to receiving this message, the process identifies the failure type and history (operation 1102). Thereafter, the process locates the memory model for the vehicle types (operation 1104). Next, the process observes attributes into the master model (operation 1106). In operation 1106, the attributes are observed into the model by writing the attributes into appropriate associative memories or creating new associative memories as needed.

The mobile client state is retrieved for the mobile client (operation 1108). Operation 1108 retrieves a state for a particular mobile client for the vehicle type that has not yet been processed. This state identifies the state of the client, which includes information about the mobile memory that is currently being used by the client. In this example, the mobile client state is retrieved for mobile client of the vehicle type for which the failure has occurred.

Thereafter, a delta or difference is computed between the memory model for the mobile client and the master model (operation 1110). Operation 1110 is used to identify what associative memories may be missing from the mobile client when compared to the current master model of the mobile memory used by the mobile client.

The delta or difference between the memory model for the mobile client in the master model may depend on the last time the mobile client connected to the server to receive an update. Connectivity failures may require more updates for some mobile clients than others for the same vehicle type.

The delta or difference between the memory models is transmitted to the mobile client (operation 1112). Next, a determination is made as to whether additional mobile clients are present for processing that have not been processed (operation 1114). If additional mobile clients are present, the process returns to operation 1108. Otherwise, the process terminates.

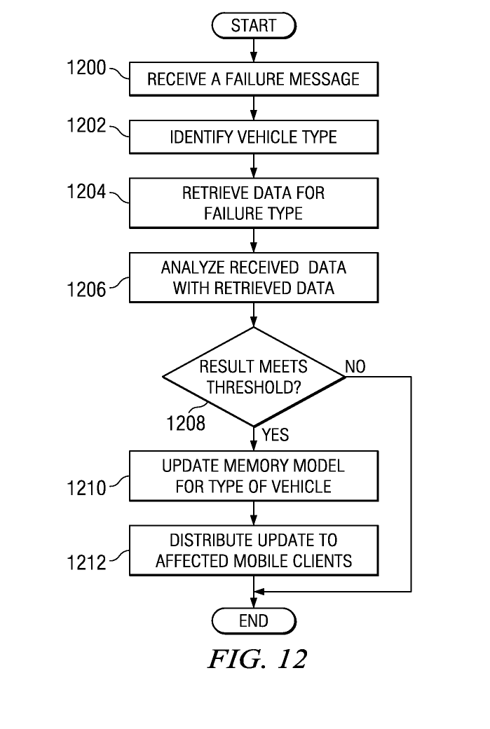

Turning now to FIG. 12, a flowchart of a process for analyzing a failure received from a mobile client is depicted in accordance with an advantageous embodiment of the present invention. The process illustrated in FIG. 12 may be implemented in a server process, such as server process 302 in FIG. 3. In particular, the process illustrated in this figure may be implemented in a mobile memory server, such as mobile memory server 314 in FIG. 3.

The process begins by receiving a failure message (operation 1200). This failure message is a message received from a mobile client containing attribute information relating to a failure that has been detected by that mobile client on the vehicle on which the mobile client is operating. The process then identifies the vehicle type on which the mobile client is operating (operation 1202).

Thereafter, the process retrieves data for the failure type (operation 1204). The data retrieved in operation 1204 is retrieved from a master database, such as master database 316 in FIG. 3. The data may include data relevant to failures for the different mobile clients as well as other incidents that may not be tracked using mobile clients. Next, the received data is analyzed with the retrieved data (operation 1206).

A determination is made as to whether the results meet a threshold (operation 1208). The determination operation 1208 may be made using different processes, such as a statistical analysis or artificial intelligence process. If the result of the analysis meets the threshold, then the memory model for the type of vehicle is updated (operation 1210). Then, the update is distributed to all affected mobile clients (operation 1212) with the process terminating thereafter. With reference again to operation 1208, if the result does not meet a threshold, the process terminates without changing the mobile memory for the type of vehicle.

The process illustrated in FIG. 12 may be applied to processing other types of messages received from mobile clients. For example, the message may be one containing an event in the form of an anomaly detected by a mobile client. In these examples, an anomaly may be present when data is detected that does not meet the past history of data collected and stored by the mobile client. For example, a temperature spike that occurs more than some selected number of times that exceeds the normally observed memory temperatures may be considered anomaly to be reported to the mobile memory server. This and other sensor data collected during the anomaly may be sent to the mobile memory server for analysis. By analyzing the anomaly, the mobile memory server may be able to determine that the failure or performance degradation may occur when such an anomaly is present.

Although these examples are directed towards vehicles, the different processes illustrated above may be implemented in mobile clients for any type of node. Further, the illustrative embodiments are directed towards and predicting failures and analyzing the occurrence of failures. The sharing of knowledge may be applied to other types of implementations. For example, the different advantageous embodiments may be applied to onboard strategy or tactics. For example, nodes in the form of tanks may be pre-populated with information about successful engagement tactics. The mobile clients using engagement tactic information supplied in the memory model may suggest how to engage enemies that are encountered. With these mobile clients, some tanks may attempt new tactics that are successful with those tactics being transmitted and shared with other mobile clients. As a result, the different advantageous embodiments may be applied to any situation in which rules may change, experience gained by a particular node may be used to generate new rules, and a network is available to share this information with other nodes.

In this manner, the different illustrative embodiments allow for shared learning knowledge across different nodes in a mobile intelligence system. A mobile client executing on a node may process data and increase its knowledge based on conclusions and results made from processing data that the mobile client observes. Further, this knowledge may be passed on to other mobile clients to allow the other mobile clients to learn from the experience of this particular mobile client. Thus, the experiences of one mobile client may be shared with others to increase the knowledge of the mobile clients as a whole.

Further, the different illustrative embodiments allow a server process to analyze observations made by mobile clients with observations made by other mobile clients. By analyzing the observations made by many mobile clients, the server process may generate observations that an individual mobile client is unable to make. These observations may be placed into updates that are distributed to the other mobile clients. In addition, the agent and the memory model making up a mobile client at a node allows for the mobile client to make intelligent decisions even when the mobile client cannot communicate with the mobile memory server.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The description of the present invention has been presented for purposes of illustration and description, and is not intended to be exhaustive or limited to the invention in the form disclosed. Many modifications and variations will be apparent to those of ordinary skill in the art. For example, although the depicted embodiments are directed towards nodes that take the form of vehicles, the embodiments illustrated may be applied to other types of nodes. For example, these features may be implemented for use in personal devices, such as personal digital assistants, in which the sensors may detect data, such as user input or operating conditions in the device and the environment around the device. The different processes also may be applied to nodes that have physical or wired connections in a network data processing system. Further, different advantageous embodiments may provide different advantages as compared to other advantageous embodiments. The embodiment or embodiments selected are chosen and described in order to best explain the principles of the invention, the practical application, and to enable others of ordinary skill in the art to understand the invention for various embodiments with various modifications as are suited to the particular use contemplated.

What is claimed is:

1. A network data processing system comprising:
a server; and
a plurality of mobile clients, wherein each mobile client executes on a node using an artificial intelligence process and a memory model located at the node, receives data from a set of sensors associated with the node to form sensor data, processes the sensor data using the artificial intelligence process and the memory model, identifies an action based on processing the sensor data, selectively sends results from processing the sensor data to the server in response to encountering a selected event at the node, and receives an update to the memory model based on other results from another mobile client, wherein the update provides an ability to process sensor data with respect to new events.

2. The network data processing system of claim 1, wherein the server processes the results to generate the update and sends the update to the plurality of mobile clients.

3. The network data processing system of claim 2, wherein in processing the results, the server analyzes the results using prior results received from the plurality of mobile clients.

4. The network data processing system of claim 3, wherein the results comprise sensor data.

5. The network data processing system of claim 1, wherein the action is selected from at least one of generating a warning, saving the processed data in the memory model, and no action.

6. The network data processing system of claim 3, wherein the results are based on the processed data sent to the server, and the server processes the results received from the mobile client with respect to data associated with the plurality of mobile clients to form a new update, and the server sends the new update to the plurality mobile clients.

7. The network data processing system of claim 1, wherein the artificial intelligence process in a mobile client processes the sensor data using the sensor data and historical data stored by the mobile client.

8. The network data processing system of claim 1, wherein the selected event is a failure of a component on the node.

9. The network data processing system of claim 1, wherein the memory model originates from a master model, wherein the master model includes a selected memory model for each type of node present in the network data processing system.

10. The network data processing system of claim 1, wherein the artificial intelligence process includes at least one of an artificial intelligence program, a fuzzy logic system, and a neural network.

11. The network data processing system of claim 1, wherein the plurality of mobile clients communicates with the server using intermittent communications links.

12. The network data processing system of claim 1, wherein the sensor data is processed by the artificial intelligence process to determine whether a maintenance action is needed to prevent a failure from occurring on the node.

13. The network data processing system of claim 1, wherein the plurality of nodes is selected from a plurality of aircraft, a plurality of ships, and a plurality of trucks.

14. The network data processing system of claim 1, wherein the selected event is at least one of a failure of a component in the node or an anomaly in the sensor data.

15. A computer implemented method for processing sensor data, the computer implemented method comprising:
monitoring a set of sensors associated with a node on which the computer implemented method is executing to obtain sensor data;
processing the sensor data using an artificial intelligence process to identify an action;
updating a memory model stored on the node based on the processing of the sensor data to form an updated memory model;
sending a message to a server on a network data processing system if the action identified from processing the sensor data indicates that a message is to be sent to the server; and
responsive to receiving an update from the server, updating the memory model using the update to form an updated memory model, wherein subsequent processing of sensor data is made using the updated memory model.

16. The computer implemented method of claim 15, wherein the sending step comprises:
sending a message to a server on a network data processing system if the action identified from processing the sensor data indicates that a message is to be sent to the server in which the message comprises the sensor data and an identification of a failure of a component in the node.

17. The computer implemented method of claim 15, wherein the processing step comprises:
processing the sensor data using an artificial intelligence process to identify an action in which the artificial intelligence process comprises at least one of an artificial intelligence program, a fuzzy logic system, and a neural network.

18. The computer implemented method of claim 15, wherein the updating step comprises:
responsive to receiving an update from the server, updating the memory model using the update to form an updated memory model, wherein the update is generated by the server processing messages from a plurality of mobile clients and subsequent processing of sensor data is made using the updated memory model.

19. The computer implemented method of claim 15, wherein the updating step comprises:
updating a memory model stored on the node based on the processing of the sensor data to form an updated memory model in which the memory model comprises a plurality of associative memories and wherein the update is a new associative memory absent from the plurality of associative memories.

20. A computer program product comprising:
a computer usable medium having computer usable program code for processing sensor data, the computer usable program code comprising:
computer usable program code for monitoring a set of sensors associated with a node on which the computer usable program code is executing to obtain sensor data;
computer usable program code for processing the sensor data using an artificial intelligence process to identify an action;
computer usable program code for updating a memory model stored on the node based on the processing of the sensor data to form an updated memory model;
computer usable program code for sending a message to a server on a network data processing system if the action identified from processing the sensor data indicates that a message is to be sent to the server; and
computer usable program code, responsive to receiving an update from the server, for updating the memory model using the update to form an updated memory model, wherein subsequent processing of sensor data is made using the updated memory model.
